(19) United States
(12) Patent Application Publication
(10) Pub. No.: US 2025/0108731 A1
(43) Pub. Date: Apr. 3, 2025

(54) VEHICLE SEAT

(71) Applicants: TOYOTA BOSHOKU KABUSHIKI KAISHA, Aichi (JP); TOYOTA JIDOSHA KABUSHIKI KAISHA, Aichi-ken (JP); AISIN CORPORATION, Aichi (JP)

(72) Inventors: Yuya INOUE, Toyota-shi (JP); Masahiko ONUMA, Toyota-shi (JP); Shintaro NISHIKAWA, Kariya-shi (JP); Akiyoshi SHIBATA, Kariya-shi (JP)

(73) Assignees: TOYOTA BOSHOKU KABUSHIKI KAISHA, Aichi (JP); TOYOTA JIDOSHA KABUSHIKI KAISHA, Aichi-ken (JP); AISIN CORPORATION, Aichi (JP)

(21) Appl. No.: 18/893,159

(22) Filed: Sep. 23, 2024

(30) Foreign Application Priority Data
Sep. 28, 2023 (JP) 2023-167746

(51) Int. Cl. B60N 2/02; B60N 2/12

(52) U.S. Cl. CPC B60N 2/0244; B60N 2/12; B60N 2/02253

(57) ABSTRACT

One aspect of the present disclosure provides a vehicle seat including an electric motor, a movable portion, an operation switch, and a controller. The movable portion receives a driving force from the electric motor to thereby move in a direction corresponding to a rotation direction of the electric motor. The controller rotates the electric motor in a first rotation direction in response to the operation switch outputting an ON signal. The controller performs a rotation inverting control in response to the controller having detected the movable portion in its movement interrupted state for a first preset time period. In the rotation inverting control, the controller rotates the electric motor in a second rotation direction opposite to the first rotation direction.

### CROSS-REFERENCE TO RELATED APPLICATIONS

The present application claims the priority of Japanese Patent Application No. 2023-167746 filed on Sep. 28, 2023 with the Japan Patent Office, the entire disclosure of which is incorporated herein by reference.

### BACKGROUND

The present disclosure relates to a vehicle seat configured to be mounted to a vehicle.

Japanese Unexamined Patent Application Publication No. 2008-136325 discloses a seat device. In this seat device, in response to a detection indicating that a movement of a movable portion is interrupted by a foreign object, a rotation direction of an electric motor is immediately inverted, which in turn inverts a moving direction of the movable portion.

### SUMMARY

The immediate inverted movement of the movable portion in response to such a movement interrupted detection may be an operation of the movable portion contrary to a user's intention. The user therefore may feel a great sense of discomfort to such an operation of the movable portion.

It is desirable that one aspect of the present disclosure provides a vehicle seat that can reduce a user's discomfort to an operation of a movable portion of the vehicle seat in response to a movement interrupted detection.

One aspect of the present disclosure provides a vehicle seat configured to be mounted to a vehicle. The vehicle seat comprises an electric motor, a movable portion, an operation switch, and a controller. The electric motor is configured to generate a driving force. The movable portion is configured to receive the driving force from the electric motor to thereby move in a direction corresponding to a rotation direction of the electric motor. The operation switch is configured (i) to be manually operated by a user and (ii) to output an ON signal in response to the operation switch being manually operated. The controller is configured to rotate the electric motor in a first rotation direction in response to the operation switch outputting the ON signal. The controller is configured to detect the movable portion in its movement interrupted state at least based on (i) the operation switch outputting the ON signal and (ii) a rotation of the electric motor being stopped. The controller is configured to perform a rotation inverting control in response to the controller having detected the movable portion in its movement interrupted state for a first preset time period. The movable portion in its movement interrupted state is unable to move in the direction corresponding to the first rotation direction of the electric motor. The rotation inverting control is configured for the controller to rotate the electric motor in a second rotation direction opposite to the first rotation direction.

In the vehicle seat configured as mentioned above, the movable portion does not move in its inverted direction immediately after the movable portion in its movement interrupted state is detected. The vehicle seat therefore can reduce the user's discomfort to the operation of the movable portion in response to the movement interrupted detection.

The ON signal may be a negative logic signal (or an active-low signal) or a positive logic signal (or an active-high signal).

The first rotation direction may correspond to a nominal rotation direction of the electric motor or a reverse rotation direction of the electric motor.

The controller may be configured to be enabled to perform the rotation inverting control at least when the vehicle is stationary.

The movable portion may be a seat body configured to move along a front-rear axis of the vehicle seat corresponding to the rotation direction of the electric motor. The controller may be configured to be enabled to perform the rotation inverting control at least when the seat body moves rearward of the vehicle seat.

The movable portion may be a seatback configured (i) to support an occupant's back and (ii) to tilt with respect to a front-rear axis of the vehicle seat corresponding to the rotation direction of the electric motor. The controller may be configured to be enabled to perform the rotation inverting control at least when the seatback tilts backward of the vehicle seat.

The movable portion may be a seat body configured to move along an up-down axis of the vehicle seat corresponding to the rotation direction of the electric motor. The controller may be configured to be enabled to perform the rotation inverting control at least when the seat body moves downward of the vehicle seat.

The controller may be configured to detect the movable portion in its movement interrupted state base on the movable portion having maintained its movement interrupted state for a preset detecting period. The vehicle seat with the controller configured as such can reduce erroneous detections of the movable portion in its movement interrupted state.

The vehicle seat may comprise a rotation sensor configured to output a pulse signal in association with the rotation of the electric motor. The movable portion in its movement interrupted state may cause the rotation sensor not to output the pulse signal while the operation switch is outputting the ON signal.

The movable portion in its movement interrupted state may keep increasing a conduction current flowing through the electric motor while the operation switch is outputting the ON signal.

The controller may be configured to output, to the electric motor, a supply voltage having a first magnitude (or a first absolute value) in response to (i) the operation switch outputting the ON signal and (ii) the controller not detecting the movable portion in its movement interrupted state. The controller may be configured to perform a motor load reducing control before performing the rotation inverting control in response to the controller detecting the movable portion in its movement interrupted state. The motor load reducing control may be configured for the controller to output, to the electric motor, the supply voltage having a second magnitude (or a second absolute value) smaller than the first magnitude.

In the vehicle seat with the controller configured as such, when the movable portion is in its movement interrupted state, the conduction current flowing through the electric motor can be reduced, and the resulting damage to the motor can be suppressed.

### BRIEF DESCRIPTION OF THE DRAWINGS

Example embodiments of the present disclosure will be described hereinafter with reference to the accompanying drawings, in which:

FIG. 1 is a schematic diagram of a vehicle seat according to a first embodiment;

FIG. 2 is a schematic diagram of a control device of an electric motor according to the first embodiment;

FIG. 3 is a time chart illustrating a control of the electric motor in the first embodiment;

FIG. 4 is a time chart illustrating a control of the electric motor in a second embodiment; and

FIG. 5 is a time chart illustrating a control of the electric motor in a third embodiment.

### DETAILED DESCRIPTION OF EXEMPLARY EMBODIMENTS

Embodiments to be described below are merely examples of embodiments that fall within the technical scope of the present disclosure. In other words, the appended claims are not limited to specific configurations or structures shown in the embodiments below.

The embodiments below provide some examples of the vehicle seat that is configured to be mounted to a motor vehicle (not shown). At least a member or portion that is described with a reference numeral is at least one in number except in a case of being accompanied by restrictive words such as “only one of”.

In other words, there may be two or more of such a member or portion when the number is not specified as “only one of” or the like. The vehicle seat according to the present disclosure comprises at least one of components described with a reference numeral and/or shown in the drawings.

### 1. First Embodiment

### 1-1. Overview of Vehicle Seat

### 1-1-1. Structure of Vehicle Seat

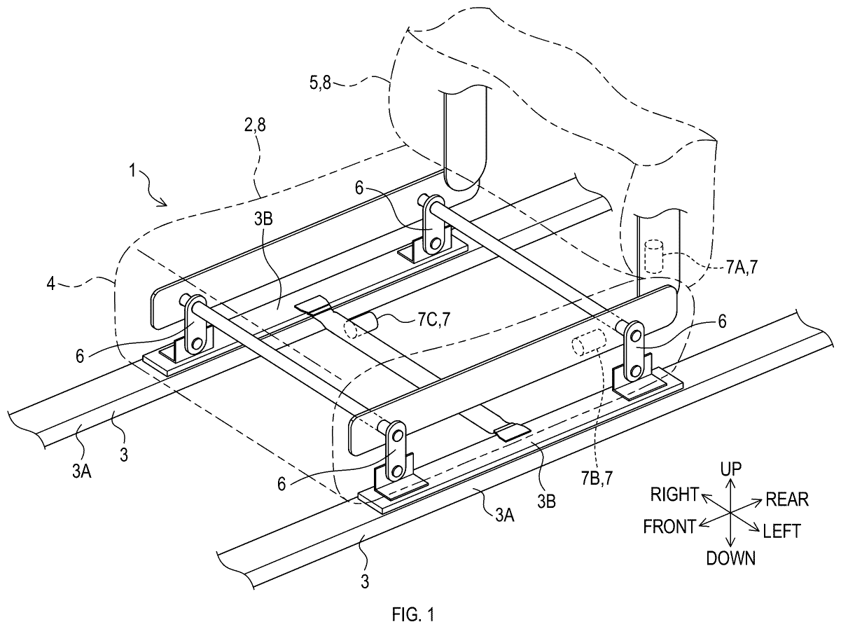

As shown in FIG. 1, the vehicle seat 1 includes at least a seat body 2 and a pair of sliding devices 3. The seat body 2 includes at least a seat cushion 4 and a seatback 5 and is configured for a user to be seated thereon.

The seat cushion 4 is configured to support an occupant's buttocks. The seatback 5 is configured to support the occupant's back. The seatback 5 is tiltably (or pivotably) coupled to a rear-end side of the seat cushion 4.

Specifically, the seatback 5 can pivot at its lower-end side and tilt (or recline) with respect to the seat cushion 4 along a front-rear axis of the vehicle seat 1. The pair of sliding devices 3 slidably support the seat body 2.

The pair of sliding devices 3 is arranged on a first-end side and a second-end side of the seat body 2 in its width direction to support the seat body 2. Each sliding device 3 includes a fixed rail 3A and a movable rail 3B.

Each fixed rail 3A is a rail member secured to the motor vehicle. Each movable rail 3B is slidably mounted on the corresponding fixed rail 3A. The seat body 2 is coupled to each movable rail 3B via two or more lifter links 6.

In the first embodiment, each fixed rail 3A is secured to the motor vehicle such that the longitudinal direction thereof coincides with the front-rear axis of the vehicle seat 1. Thus, the seat body 2 according to the first embodiment can slide along the front-rear axis of the vehicle seat 1.

Each lifter link 6 has its upper end pivotably coupled to the seat cushion 4 and its lower end pivotably coupled to the corresponding movable rail 3B. Thus, the lifter links 6 pivot in conjunction with each other, thereby moving the seat cushion 4 along an up-down axis of the vehicle seat 1.

Accordingly, the seat body 2 and the seatback 5 each correspond to a movable portion of the vehicle seat 1. The seat body 2 can move along the front-rear axis and the up-down axis of the vehicle seat 1. The seatback 5 can tilt with respect to the front-rear axis of the vehicle seat.

The vehicle seat 1 includes first through third electric motors 7A through 7C. The first electric motor 7A is configured to generate a driving force for tilting the seatback 5 with respect to the front-rear axis of the vehicle seat 1. The second electric motor 7B is configured to generate a driving force for moving the seat body 2 along the up-down axis of the vehicle seat 1. The third electric motor 7C is configured to generate a driving force for moving the seat body 2 along the front-rear axis of the vehicle seat 1. In another embodiment, the vehicle seat 1 may include only one or only two of the first through third electric motors 7A through 7C. In still another embodiment, the vehicle seat 1 may include at least one additional electric motor in addition to the first through third electric motors 7A through 7C.

It is to be noted that the term “electric motor 7” refers to any one of the electric motors 7A through 7C, and the term “movable portion 8” refers to a movable portion, namely the seat body 2 or the seatback 5, that moves upon receipt of a driving force from the “electric motor 7”.

That is, in cases where the electric motor 7 refers to the first electric motor 7A, the movable portion 8 refers to the seatback 5. In cases where the electric motor 7 refers to the second electric motor 7B or the third electric motor 7C, the movable portion 8 refers to the seat body 2.

### 1-1-2. Overview of Movable Portion Control

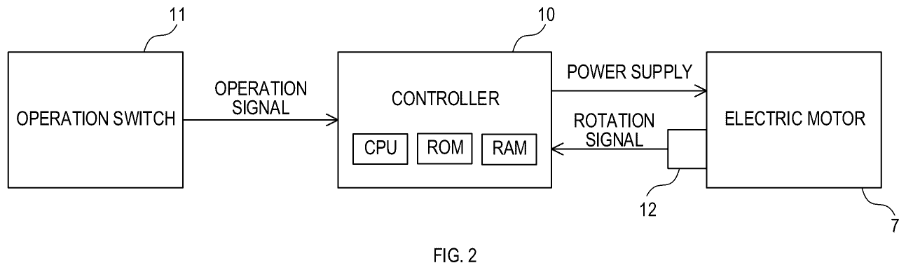

FIG. 2 shows a control device of the electric motor 7 according to the first embodiment. The control device includes at least a controller 10, an operation switch 11 and a rotation sensor 12. The controller 10 is configured to control the electric motor 7.

More specifically, in the first embodiment, the controller 10 is a microcomputer-based electronic control unit that includes a CPU, a ROM, and a RAM. Software for the controller 10 to perform a below-described rotation inverting control is stored in advance in a non-volatile memory device such as the ROM. The controller 10 receives not-shown signals each indicating a state of the motor vehicle such as a traveling speed and acceleration of the motor vehicle.

The operation switch 11 is configured to be manually operated by the user to thereby output an operation signal to the controller 10. The operation signal refers to a signal to rotate the electric motor 7 in a nominal rotation direction or a reverse rotation direction.

In a state where the operation signal is output, the controller 10 delivers an electric power to the electric motor 7 in accordance with the operation signal to rotate the electric motor 7 in the nominal rotation direction or the reverse rotation direction. When the operation signal is not output, the controller 10 stops delivering the electric power to the electric motor 7 to thereby stop the electric motor 7.

The rotation sensor 12 is configured to detect a rotation of the electric motor 7 and to output a pulse signal to the controller 10. More specifically, the rotation sensor 12 outputs a string of pulses. The number of pulses included in the string of pulses is proportional to the rotational frequency of the electric motor 7. The controller 10 determines based on the pulse signal whether the electric motor 7 is rotating. More specifically, the controller 10 recognizes the rotational frequency of the electric motor 7 based on the number of pulses received by the controller 10 per unit time.

### 1-2. Details of Electric Motor Control

In the vehicle seat 1, the moving direction of the movable portion 8 is inverted in response to inverting of the rotating direction of the electric motor 7 that is rotating in the nominal rotation direction or the reverse rotation direction.

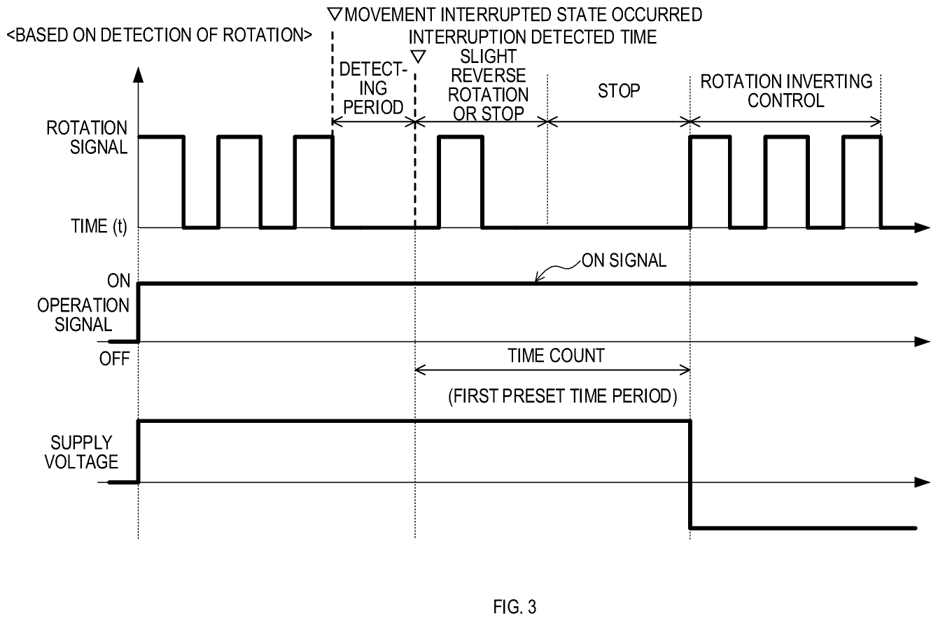

As shown in FIG. 3, in the first embodiment, the controller 10 performs the rotation inverting control in response to continuous output of an ON signal from the operation switch 11 from an interruption detected time until an end of a first preset time period. With this rotation inverting control, the rotation of the electric motor 7 is inverted.

The ON signal refers to the operation signal output from the operation switch 11 to operate the electric motor 7. The controller 10 rotates the electric motor 7 in the nominal rotation direction or the reverse rotation direction based on receipt of the ON signal. In the first embodiment, the operation switch 11 includes an active-low switch circuit configured to output a negative logic signal (e.g. a signal having a voltage of 0 volts) as the ON signal. In another embodiment, the operation switch 11 may include an active-high switch circuit configured to output a positive logic signal (e.g. a signal having a voltage of 5 volts) as the ON signal.

The interruption detected time refers to a time point when (i) the ON signal is being output and (ii) the controller 10 determines that the electric motor 7 is stopped. The interruption detected time more specifically means as follows. The controller 10 delivers a supply voltage to the electric motor 7 upon receipt of the ON signal. The electric motor 7 rotates when the movable portion 8 is not in its movement interrupted state, and thereby the controller 10 regularly receives the pulse signal.

However, in a case where the movable portion 8 is in its movement interrupted state, the rotation sensor 12 does not output the pulse signal or irregularly outputs the pulse signal. At a time point when a duration of this state has exceeded a preset detecting period since occurrence of this state, the controller 10 detects the movable portion 8 in its movement interrupted state.

In the first embodiment, the controller 10 is enabled to perform the rotation inverting control when (i) the motor vehicle is stationary and (ii) the movable portion 8 moves in a direction in which its movement interrupted state may occur. In other words, the controller 10 does not perform the rotation inverting control when the motor vehicle is moving.

Example cases of “the movable portion 8 moves in a direction in which its movement interrupted state may occur” includes (i) a case where the seat body 2 moves rearward of the vehicle seat 1, (ii) a case where the seat body 2 moves downward of the vehicle seat 1, and (iii) a case where the seatback 5 tilts rearward of the vehicle seat 1.

### 1-3. Features of First Embodiment

In the vehicle seat 1 according to the first embodiment, the rotation inverting control is performed in response to the ON signal having been continuously output since the interruption detected time until the end of the first preset time period. Thus, the vehicle seat 1 can reduce the user's discomfort to an operation of the movable portion 8 in response to the movement interrupted detection.

In the first embodiment, the operation switch 11 outputs the negative logic signal as the ON signal. Thus, the operation switch 11 may output the ON signal when the circuit of the operation switch 11 is shorted to the ground of the not-shown electric system of the vehicle seat 1. Such an ON signal is not the ON signal intended by the user.

In the first embodiment, even when the electric motor 7 is operated by the ON signal which is not intended by the user, the rotation inverting control is performed in response to the ON signal having been continuously output since the interruption detected time until the end of the first preset time period. This helps in reducing the user's discomfort to such an operation.

### 2. Second Embodiment

As shown in FIG. 3, in the above-described first embodiment, the controller 10 does not vary the supply voltage delivered to the electric motor 7 after the movable portion 8 in its movement interrupted state is detected until the rotation inverting control is performed.

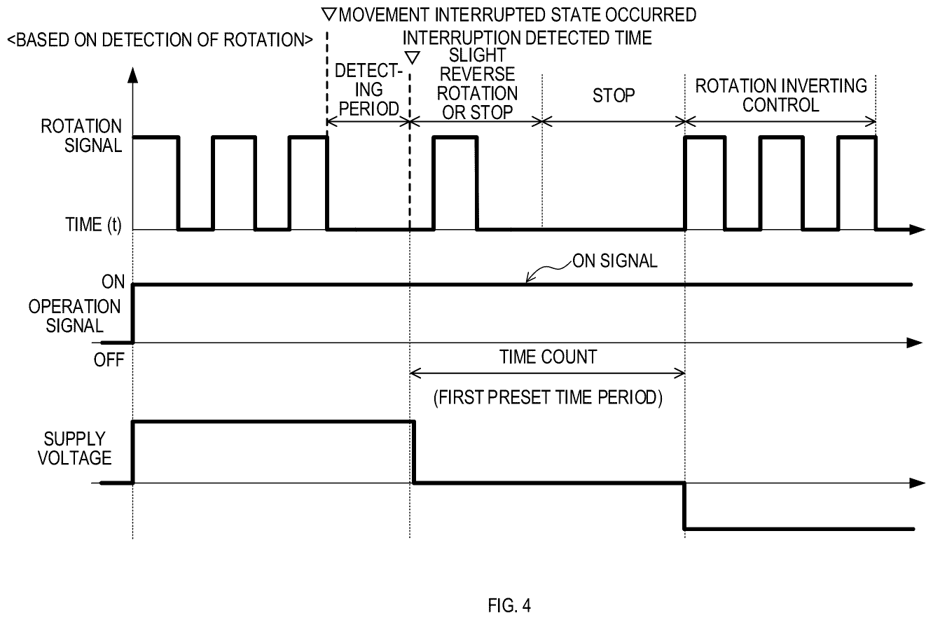

In contrast, as illustrated in FIG. 4, the controller 10 according to the second embodiment performs a motor load reducing control from the interruption detected time until a start of the rotation inverting control. In the motor load reducing control, the controller 10 reduces a magnitude (or an absolute value) of the supply voltage to a magnitude smaller than that of the supply voltage before the interruption detected time. More specifically, in a case where the supply voltage before the interruption detected time is, for example, “+12 V”, the supply voltage during the motor load reducing control is varied to +3 volts, 0 volts, or −3 volts, for example. The supply voltage of +3 volts has the polarity in which the electric motor 7 rotates in the nominal rotation direction. The supply voltage of −3 volts has the polarity in which the electric motor 7 rotates in the reverse rotation direction. The magnitude of the supply voltage during the rotation inverting control is greater than that of the supply voltage during the motor load reducing control.

In such a vehicle seat 1 according to the second embodiment, the load of the electric motor 7 is reduced. In the second embodiment, the rotation inverting control and the motor load reducing control are performed when (i) the motor vehicle is stationary and (ii) the movable portion 8 moves in the direction in which its movement interrupted state may occur. Software for the controller 10 to perform the motor load reducing control is stored in advance in the non-volatile memory device such as the ROM.

### 3. Third Embodiment

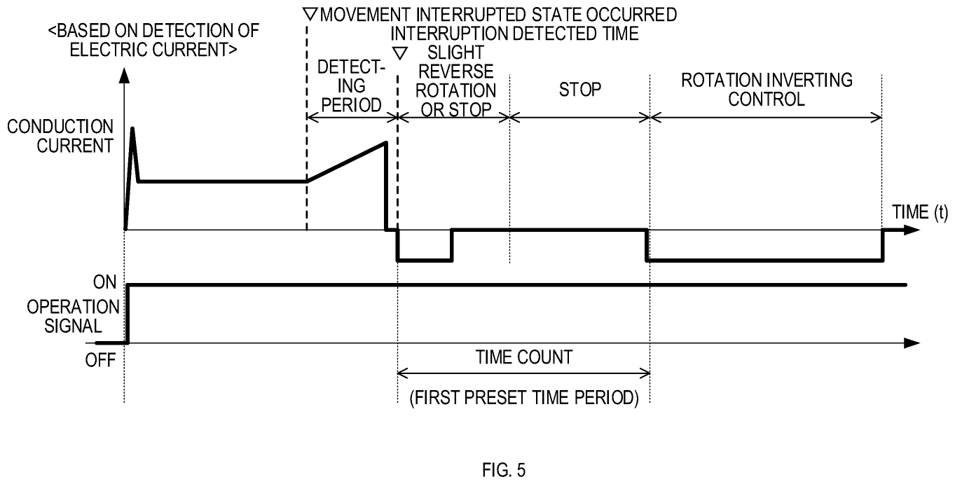

In the above-described first and second embodiments, the movable portion 8 in its movement interrupted state is detected using the rotation sensor 12. In the third embodiment, the movable portion 8 in its movement interrupted state is detected, as illustrated in FIG. 5, using variations in the conduction current flowing through the electric motor 7.

In response to the rotation of the electric motor 7 having stopped while the supply voltage is being delivered to the electric motor 7, the impedance of the electric motor 7 decreases, which in turn increases the conduction current flowing through the electric motor 7. The controller 10 according to the third embodiment is configured to detect the movable portion 8 in its movement interrupted state in response to the conduction current having continuously increased during the preset detecting period.

### 4. Other Embodiments

In the first through third embodiments, examples of the movable portion 8 are the seat body 2 and the seatback 5. However, the movable portion of the present disclosure is not limited to the seat body and the seatback, but may be another part in the vehicle seat such as an ottoman and/or a headrest.

In the first through third embodiments, the controller 10 is configured to be enabled to perform the rotation inverting control when (i) the motor vehicle is stationary and (ii) the movable portion 8 moves in the direction in which its movement interrupted state may occur. However, the present disclosure is not limited to this configuration. The controller 10 may be configured to be enabled to perform the rotation inverting control and/or the motor load reducing control, for example, (i) when the motor vehicle is moving and/or (ii) irrespective of a moving direction of the movable portion 8.

The vehicle seat of the present disclosure may be applied to a vehicle seat configured to be mounted to an another-typed vehicle, such as a railed vehicle, a ship, or an airplane, and to a stationary seat used at a theater, a home, or the like.

Furthermore, the present disclosure should not be limited to the first through third embodiments as long as it falls within the spirit of the present disclosure described in the first through third embodiments. Thus, at least two of the first through third embodiments may be combined. In any one of the first through third embodiments, any one of the elements shown in the drawings or any one of the elements described with reference numerals may be removed.

What is claimed is:

1. A vehicle seat configured to be mounted to a vehicle, the vehicle seat comprising:
an electric motor configured to generate a driving force;
a movable portion configured to receive the driving force from the electric motor to thereby move in a direction corresponding to a rotation direction of the electric motor;
an operation switch configured (i) to be manually operated by a user and (ii) to output an ON signal in response to the operation switch being manually operated; and
a controller configured:
to rotate the electric motor in a first rotation direction in response to the operation switch outputting the ON signal;
to detect the movable portion in its movement interrupted state at least based on (i) the operation switch outputting the ON signal and (ii) a rotation of the electric motor being stopped; and
to perform a rotation inverting control in response to the controller having detected the movable portion in its movement interrupted state for a first preset time period, the movable portion in its movement interrupted state being unable to move in the direction corresponding to the first rotation direction of the electric motor, the rotation inverting control being configured for the controller to rotate the electric motor in a second rotation direction opposite to the first rotation direction.

2. The vehicle seat according to claim 1,
wherein the controller is configured to be enabled to perform the rotation inverting control at least when the vehicle is stationary.

3. The vehicle seat according to claim 1, wherein:
the movable portion is a seat body configured to move along a front-rear axis of the vehicle seat corresponding to the rotation direction of the electric motor; and
the controller is configured to be enabled to perform the rotation inverting control at least when the seat body moves rearward of the vehicle seat.

4. The vehicle seat according to claim 1, wherein:
the movable portion is a seatback configured (i) to support an occupant's back and (ii) to tilt with respect to a front-rear axis of the vehicle seat corresponding to the rotation direction of the electric motor; and
the controller is configured to be enabled to perform the rotation inverting control at least when the seatback tilts backward of the vehicle seat.

5. The vehicle seat according to claim 1, wherein:
the movable portion is a seat body configured to move along an up-down axis of the vehicle seat corresponding to the rotation direction of the electric motor; and
the controller is configured to be enabled to perform the rotation inverting control at least when the seat body moves downward of the vehicle seat.

6. The vehicle seat according to claim 1,
wherein the controller is configured to detect the movable portion in its movement interrupted state base on the movable portion having maintained its movement interrupted state for a preset detecting period.

7. The vehicle seat according to claim 1, further comprising
a rotation sensor configured to output a pulse signal in association with the rotation of the electric motor,
wherein the movable portion in its movement interrupted state causes the rotation sensor not to output the pulse signal while the operation switch is outputting the ON signal.

8. The vehicle seat according to claim 1,
wherein the movable portion in its movement interrupted state keeps increasing a conduction current flowing through the electric motor while the operation switch is outputting the ON signal.

9. The vehicle seat according to claim 1, wherein:
the controller is configured:
to output, to the electric motor, a supply voltage having a first magnitude in response to (i) the operation switch outputting the ON signal and (ii) the controller not detecting the movable portion in its movement interrupted state; and
to perform a motor load reducing control before performing the rotation inverting control in response to the controller detecting the movable portion in its movement interrupted state, the motor load reducing control being configured for the controller to output, to the electric motor, the supply voltage having a second magnitude smaller than the first magnitude.
